(19) United States
(12) Patent Application Publication
(10) Pub. No.: US 2020/0265393 A1
(43) Pub. Date: Aug. 20, 2020

(54) PREDICTIVE ANALYTICS FOR ABNORMAL EVENT RESOLUTIONS

(71) Applicant: HIGHRADIUS CORPORATION, Houston, TX (US)

(72) Inventors: Vishal Shah, Kandivali (W) (IN); Sonali Nanda, Miyapur (IN); Srinivasa Jami, Telangana (IN)

(21) Appl. No.: 16/411,532

(22) Filed: May 14, 2019

(30) Foreign Application Priority Data
Feb. 15, 2019 (IN) 201941006156

(51) Int. Cl. G06Q 20/10; G06Q 20/06; G06N 20/00; G06F 16/9035; G06F 9/54

(52) U.S. Cl. CPC G06Q 20/102; G06Q 20/06; G06F 9/542; G06F 16/9035; G06N 20/00

(57) ABSTRACT

Systems are provided to utilize machine learning to identify abnormal event resolutions and provide guidance for resolution. For example, in a two-way event system, a normal response will typically close the loop on an initially generated event. However, there are cases where processing of the event uncovers contingent response strategies. In an accounting implementation, machine learning techniques are used to identify the potential of a deduction to be invalid. Machine learning algorithms are trained based on historical deductions and their resolution attributes. Models may further be used to predict whether a deduction is valid or invalid. Contingencies addressed include shortages, pricing adjustments, promotional activity, and other types of deductions that may occur in a provider, supplier, and consumer account resolution system. Automation allows focus on invalid deductions and may automatically close non-cost effective events as having been resolved without further inquiry or research.

### CROSS-REFERENCE TO RELATED APPLICATIONS

This application claims the benefit of Indian Appl. No. 201941006156, filed Feb. 15, 2019. This application is incorporated herein by reference in its entirety to the extent consistent with the present application.

### BACKGROUND

In an event driven computer system, it is common for an initiating event to have a response event to “resolve” a situation that may have been identified by the first event. This may be referred to as a two-way event system. For example, if a threshold within a monitoring system issues an event that a CPU is above that CPU's monitored threshold, then a response event may be generated to tell the monitoring system to ignore the event, reset the threshold to a higher value, or that the CPU has returned below its threshold for a long enough period of time to close the initial event.

Other types of data analysis systems may similarly utilize two-way events to maintain process flow of task items through a controlled system. As already mentioned, this may be common for an automated system monitoring of enterprise thresholds but also may be of value to monitor transaction flow for other types of real-world transactions. Specifically, one type of real-world transaction that may be monitored and have abnormal event returns is a credit payment system. In a computer-based credit payment system, a first entity purchases goods or services from second entity. If a first entity is a business and the second entity is a consumer, this is referred to using the acronym as “B2C.” In a slightly different model, but having significant overlap, a first entity and a second entity may both be a business. This business to business model is referred to using the acronym “B2B.”

To address the above problems associated with abnormal event resolution scenarios, systems and methods disclosed herein to reduce manual effort on the part of a collection analyst or other user.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not require serial processing and therefore may be performed in an order different than shown or possibly in parallel with each other. For a detailed description of various examples, reference will now be made to the accompanying drawings, in which:

FIG. 1 is a block diagram illustrating an incorrect delivery of goods or services resulting in a deduction request, according to one or more disclosed implementations;

FIG. 2 is a flow diagram illustrating the inefficient actions taken to process a deduction request without the benefit of this disclosure, according to one or more disclosed implementations;

FIG. 3 is a block diagram of the system components that may allow more efficient processing of a deduction request, according to one or more disclosed implementations;

FIG. 4 is a process flow diagram illustrating one example method for processing of a deduction request, according to one or more disclosed implementations;

FIG. 5 is an example computing device with a hardware processor and accessible machine-readable instructions that might be used to compile and execute the method of FIG. 4, according to one or more disclosed implementations;

FIG. 6 represents a computer network infrastructure that may be used to implement all or part of the disclosed predictive analysis for abnormal event resolutions, according to one or more disclosed implementations; and

FIG. 7 illustrates a computer processing device that may be used to implement the functions, modules, processing platforms, execution platforms, communication devices, and other methods and processes of this disclosure.

### DETAILED DESCRIPTION

Examples of the subject matter claimed below will now be disclosed. In the interest of clarity, not all features of an actual implementation are described in this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

To address problems associated with abnormal event resolution scenarios, systems and methods disclosed herein utilize machine learning to identify abnormal event resolutions and provide guidance for the abnormal resolution. That is, disclosed systems may provide guidance to a collections analyst or other users of an accounting system that are attempting to resolve anomalies in the form of deductions. If deductions are found valid, the customer invoice may be updated to reflect the valid deduction. However, if deductions are found to be invalid, further actions on the part of the collection analyst, for example, may be identified.

As introduced above, using an event driven system and abnormal event resolution techniques, systems and methods are disclosed herein to utilize machine learning to identify abnormal event resolutions and provide guidance (e.g., to a collections analyst) for the abnormal resolution. For example, in a two-way event system, there are cases where processing of the event uncovers contingent response strategies. In this business accounting example implementation, machine learning techniques are used to identify if a potential of a deduction is deemed to be invalid. Machine learning algorithms may be trained based on historical deductions and their resolution attributes. Models may further be used to predict whether a deduction is valid or invalid. Contingencies addressed include shortages, pricing adjustments, promotional activity, and other types of deductions that may occur in a provider, supplier, and consumer account resolution system.

Some businesses may purchase goods for resale from a manufacturer, while others may purchase raw materials that are made into goods for sale to consumers or other businesses. A business may have several methods they use to ensure that goods can be sold quickly, and that payment will be received for the goods that are sold. B2B commerce differs from Business-to-Consumer commerce (commonly referenced with the acronym “B2C”) where consumers purchase from a business for the primary purpose of consumption rather than resale. Many B2C transactions occur in retail stores, such as Walmart, or through on-line shopping sites, such as Amazon.

A common pattern in a B2B or B2C transaction can be observed where one party plays the role of the buyer and one party plays the role of the seller. In this context, the buyer role is seeking to receive goods or services from the seller in exchange for payment. The seller role is the provider of services or the holder of goods the seller is willing to give to a buyer in exchange for payment. In some cases, the buyer may present payment in advance or at the time when the seller delivers the goods or services. In other cases, the seller may deliver the goods or services and issue an invoice to the buyer for later payment. While the buyer will often pay the invoiced amount, there are times when the buyer may dispute all or a portion of the invoiced amount. In this context, a dispute for any portion of the invoiced amount may mean the buyer disagrees with the seller about the invoiced amount. The buyer may then pay the seller an amount that is less than the complete invoiced amount and request the seller to reduce the outstanding invoiced amount by the disputed amount, Each situation where a different amount (or nothing) is paid relative to an invoice amount may be considered an abnormal event with respect to satisfying the outstanding invoice event.

A buyer paying for an invoice by deducting the disputed amount from the total invoiced amount may create a situation referred to as a “short payment”. A buyer may make a short payment if, for example, the invoiced amount differs from an amount that was verbally communicated between the buyer and the seller, the quantity of goods delivered to the buyer is less than the quantity billed on the invoice, the goods the buyer received were damaged, the buyer feels they qualify for a promotional discount, or for some other reason.

A seller may be impacted when a buyer issues a short payment on an invoice. The seller may not agree with the buyer's reason for making a short payment and will need to come to an agreement with the buyer to collect the remaining invoice balance. In some cases, the seller may agree with the buyer's reason for the short payment and simply deduct the remaining balance from the invoiced amount (to close the outstanding invoice event). To determine an event resolution action to take for each abnormal return event, the seller may need to spend time researching the reason for each short payment. A seller that processes a small volume of sales may not have many short payments to research. However, if the volume of sales is very large, the number of employees required to research all short payments may cause a backlog of short payments to research. The backlog may increase the number of days it takes to receive payment for the remaining balance of invoices for which a buyer issued a short payment. Accordingly, an automated system to provide guidance for abnormal event returns represents an improvement to the functioning of the computer system configured to process invoice events (e.g., an accounts receivable system).

Continuing with the above example, when a buyer issues a short payment, the buyer will generally request that the remaining balance of the invoice be deducted from the invoice, To accurately track the buyer's request for a deduction from the invoiced amount, a seller may have a record keeping process to track the processing of these deductions. The deduction tracking process may begin with a record of the buyer's deduction request being delivered to a team of employees that may be responsible for researching deduction requests. The deduction research team may involve other employees in the company as part of their research. If the deduction research team's research leads to the conclusion that the deduction was valid, the time spent researching the deduction represents an inefficiency that may have been better served by simply granting the deduction. However, the deduction research team may conclude that the deduction request is invalid. In this situation the seller may further assess if the effort to recover the remaining amount will cost more than the amount to be recovered.

In traditional systems, a seller may only understand which deductions are valid and which are invalid after performing research into each requested deduction. As a first potential improvement, potentially invalid deductions may be prioritized over potentially valid deductions, for example, using machine learning techniques. Then the seller may use that priority order to perform research on the invalid deductions first so that a remaining invoice balance may be recovered from the buyer. Additionally, time spent by a deduction research team working on valid deductions represents inefficiency that may be automatically eliminated by a proper prioritization scheme. Further, time spent on valid deduction research typically delays the ability to collect remaining balances from invalid deductions. The scale of deduction requests from buyers may cause the seller to automatically approve a deduction even if it is invalid due to a cost of researching each individual deduction request.

The use of the “short payment” by a buyer to result in a deduction request is intended only as a non-limiting example of how a deduction request may be established between a buyer and a seller. Another example of a deduction request may be created when the buyer pays the full outstanding invoice balance and later disputes a portion of that payment by requesting the seller make a deduction. In this situation, if the seller later determines that the deduction request is valid, the seller may issue a credit to the buyer's account. Alternatively, the seller may send the buyer a refund in the amount of the requested deduction. There are a number of ways in which a buyer and a seller may handle actual monetary resolution of deduction requests.

A computer-implemented system where machine learning models are applied to a buyer's deduction requests may begin by categorizing and prioritizing deduction requests to allow a seller to focus on investigating specific individual deduction requests. For example, the system, configured in accordance with this disclosure, may identify as task items for abnormal event resolution that have a high likelihood of being invalid. Using machine learning techniques, deduction requests may be evaluated to produce a score that indicates a level of confidence relative to each deduction request that a particular deduction request appears to be invalid (has a high likelihood according to a machine learning model). A confidence score, in this context, may be expressed as a ratio between certain and uncertain and may be produced as a result of applying one or more machine learning algorithms to input data representing all outstanding deduction requests, for example. Further, a deduction request for a high amount may, for example, be flagged as invalid with a 90% confidence (even if the calculated score is in reality below 90%). This type of override, based on amount, may be used to indicate to a human that research about that deduction is desired. Manual research may be warranted for several reasons. Firstly, if the request is deemed invalid, a potentially large error (in the benefit of the seller) may be corrected. Secondly, automatically writing off a large deduction may lead to regulatory or other business related concerns (e.g., audit failure, etc.).

The disclosed enhanced accounts receivable system may additionally use configurable confidence thresholds combined with other data related to each deduction request to categorize the individual deduction requests. One category may be for deduction requests that may be automatically cleared. These types of deduction requests, for example, may have a low financial impact and a low confidence that the deduction request may be invalid. Deduction requests in this category may be automatically approved with little or no detriment to the seller. A category may also be established for deduction requests that should be quickly reviewed (e.g., by further analysis or a collection analyst) for approval or denial. Deduction requests in the category for quick approval may, for example, have a high financial value and a low confidence of being invalid or even a low financial value and a high confidence of being invalid.

An additional category may be established to indicate that detailed research about the deduction may be required. Deduction requests in this category may, for example, may have a high financial value and a high confidence of being invalid. Any number of categories may be established for grouping deduction requests to indicate an automatic or manual method of approval, based on a selling organization's design criteria. The categorization of deduction requests may assist in automated processing of deduction request approvals. In some cases, automated processing may be used to indicate additional research is required or initiate manual approval of the deduction request.

Categorization of deduction requests may still further improve overall accounts receivable system processing efficiency (e.g., reduce time wasted on researching deduction requests that are valid). In some implementations, rather than a single pass algorithm, each confidence score that indicates a deduction request is likely to be invalid may be processed by multiple data elements being processed cooperatively by a plurality of machine learning models. This processing may be either performed serially or performed by multiple modules in parallel. Data elements used by machine learning models may include data such as: buyer's order history, buyer's history of previous deduction requests, and data from other buyer's deduction requests. As the buyer and seller interact over time, data elements used by machine learning models to produce a confidence score may be used to improve overall accuracy of machine learning models.

Machine learning models may do further processing on deduction requests in one or more categories. Deduction requests that are categorized for detailed research, for example, may be processed by machine learning models to calculate a predicted number of days that will be required to complete the detailed research. In another example, machine learning models may be utilized to predict the number of days that will be required to recover an outstanding invoice balance if a deduction request is verified as invalid. In this manner, guidance to a collection analyst may include scheduling priority with respect to further research. The scheduling priority may be determined, for example, based on attainment of periodic goals for an organization such as quarterly revenue. Additionally, the scheduling priority may be directed toward an individual collection analyst achieving their monthly quota for collections. Other prioritization schemes are also possible.

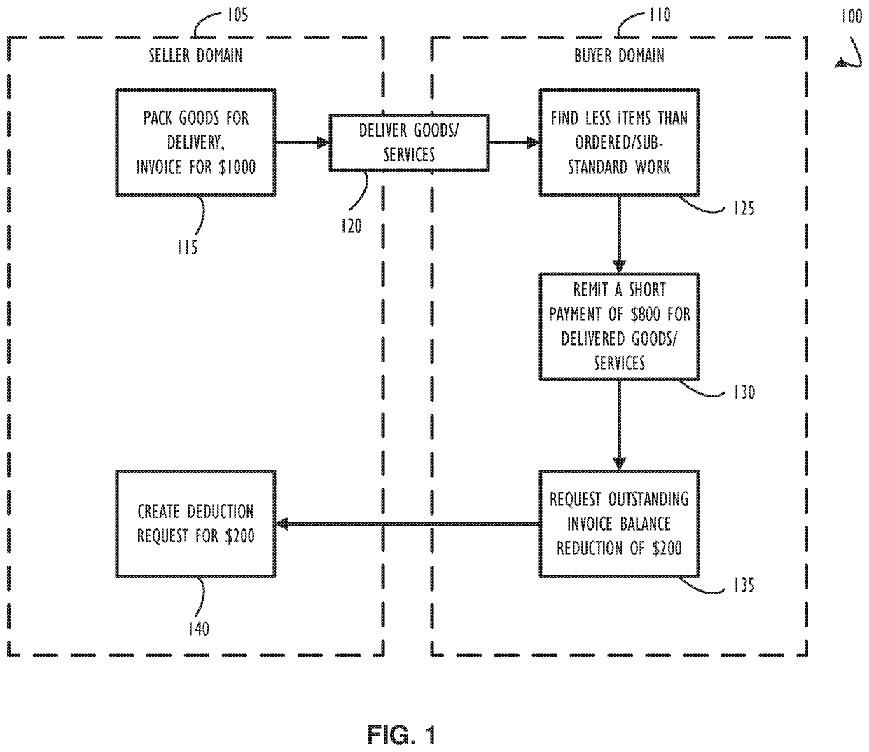

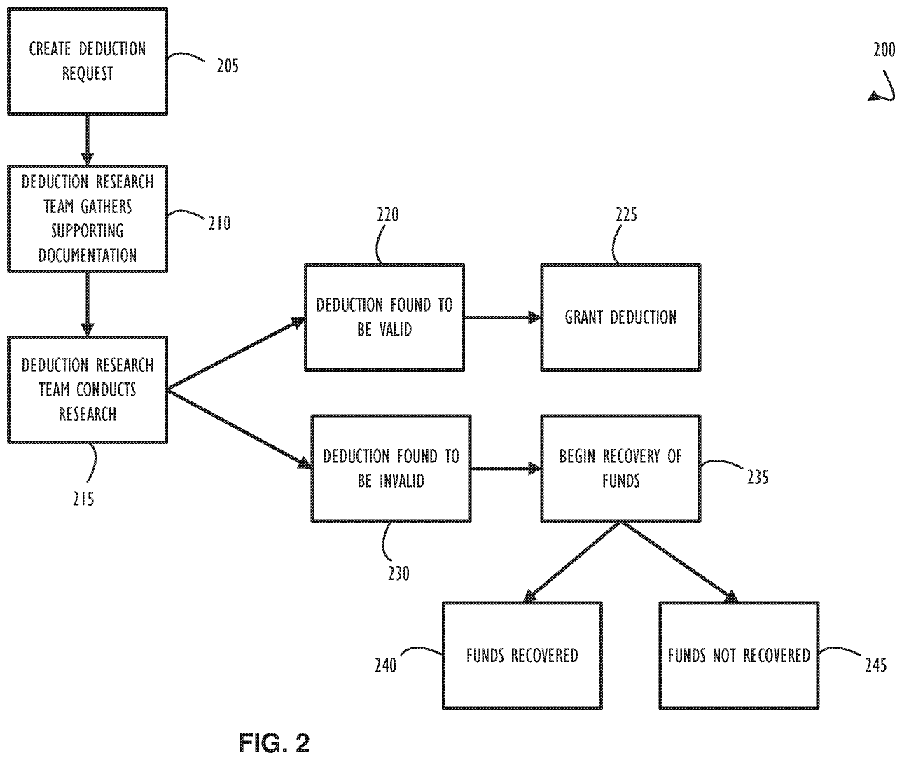

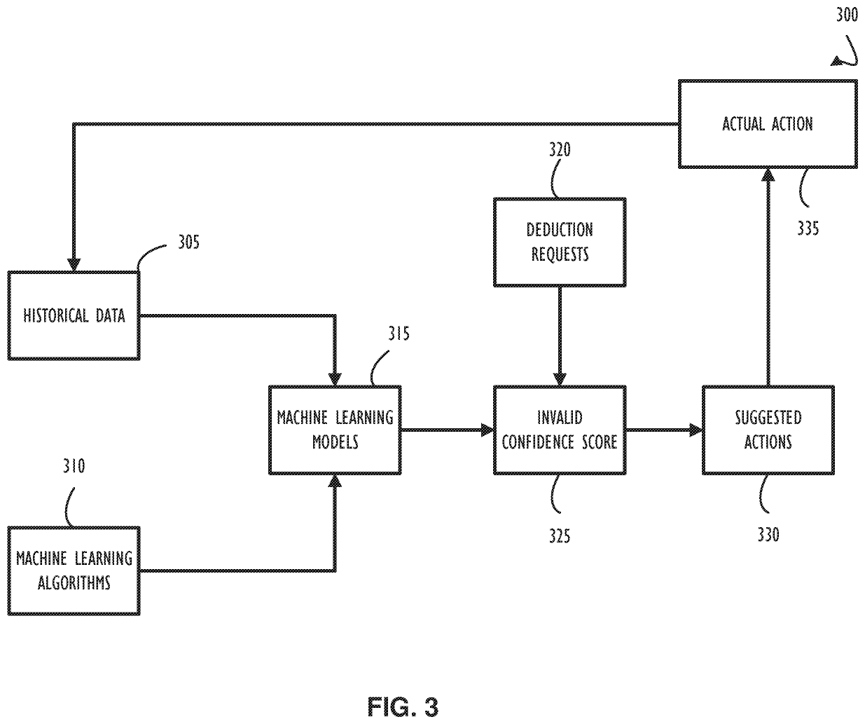

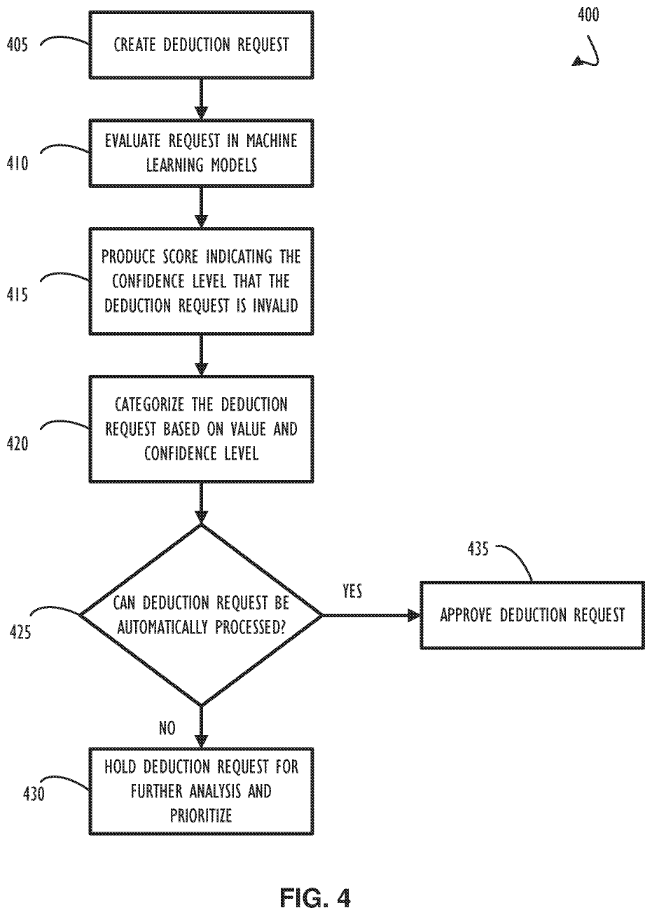

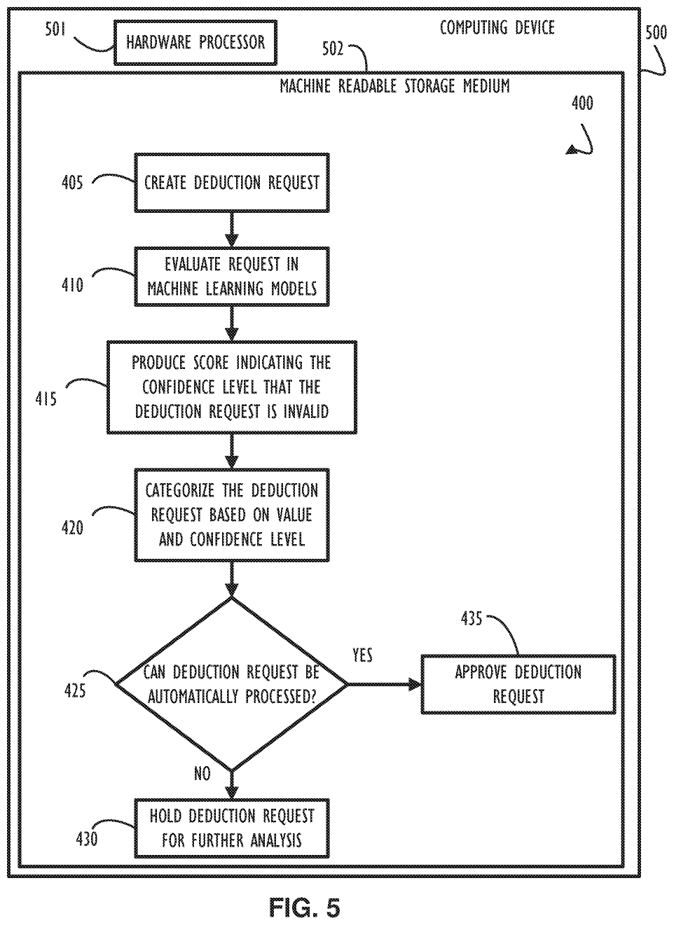

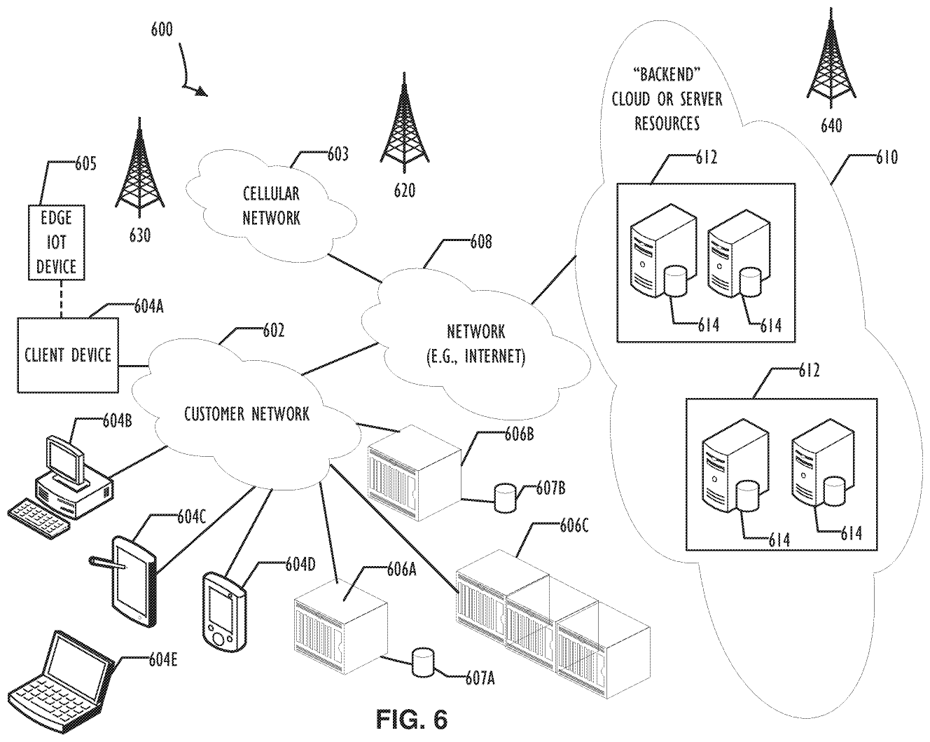

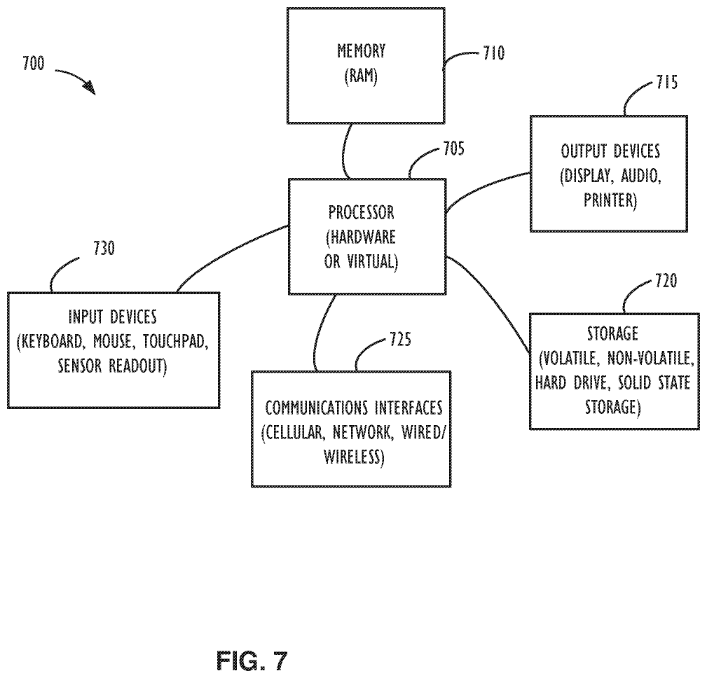

Having an understanding of the above overview, this disclosure will now explain a non-limiting but detailed example implementation. This example implementation is explained in the context of an accounts receivable automated system to identify abnormal event resolutions for invoice events. However, as mentioned above, similar concepts may be applicable to other systems that perform event loops and may have a need to address abnormal event resolutions as part of their response event processing. Reference is now made to the figures which include: a block diagram illustrating an incorrect delivery of goods or services resulting in a deduction request (FIG. 1); a flow diagram illustrating the inefficient steps taken to process a deduction request without the benefit of this disclosure (FIG. 2); a block diagram of the system components that allow the efficient processing of a deduction request (FIG. 3); a process flow diagram illustrating the efficient processing of a deduction request (FIG. 4); an example computing device with a hardware processor and accessible machine-readable instructions that might be used to compile and execute the process for efficient processing of a deduction request (FIG. 5); a computer network infrastructure that may be used to implement all or part of the disclosed efficient deduction request processing techniques, according to one or more disclosed implementations (FIG. 6); a computer processing device that may be used to implement the functions, modules, processing platforms, execution platforms, communication devices, and other methods and processes of this disclosure (FIG. 7).

Referring now to FIG. 1, a block diagram illustrating an incorrect delivery of goods or services resulting in a deduction request 100. The goods or services originate in the seller's domain 105 when goods are packaged for delivery or services are rendered and an invoice 115 is generated. Delivery of goods or services 120 transfers goods or services from the seller's domain 105 to the buyer's domain 110. Delivery of goods or services in this context refers to any type of transfer of physical goods or execution of services the seller may supply. An example of delivery of goods may be a shipment of items ordered by the buyer. An example of delivery of services may be when a seller performs a job for hire for the buyer. An example of delivery of goods may be when a buyer downloads digital content over the Internet.

The buyer, once in receipt of the goods or services and having a copy of the invoice may inspect the goods or services 125. If the buyer finds that all the goods have not been delivered or the services were performed at a sub-standard level, the buyer may remit a short payment 130 to the seller. In conjunction with remitting a short payment 130, the buyer may also request a deduction of the payable amount 135. The seller may create a deduction request 140 in their domain. The creation of a deduction request in this context may mean the seller creates appropriate records that allow the seller to research the deduction request.

Referring now to FIG. 2, shown is a flow diagram illustrating the potentially inefficient actions taken to process a deduction request 200 without using a system configured in accordance with this disclosure. Beginning with the creation of the deduction request, as illustrated in block 205, time and resources may be expended when the deduction research team begins the research process by gathering supporting documentation, as illustrated by block 210. Continuing to block 215, the deduction research team may then conduct research in an attempt to determine if a deduction request is valid or invalid. This research effort may include interviewing members of other teams, communicating with the buyer, and executing other time-intensive activities as part of the research.

If the deduction request is found to be valid, as illustrated in block 220, flow continues to block 225 where the deduction is granted. The total cost of the deduction from the seller's perspective may be represented by the amount of the requested deduction plus the cost of the resource time spent researching the validity of the deduction request. Alternatively, if the deduction request is found to be invalid, flow continues to block 230. The cost of the resource time spent researching the deduction request is typically unrecoverable and flow continues to block 235. As indicated at block 235, recovery of the deduction request amount commences. Additional resource time is typically spent in the recovery of the deduction request amount. The recovery of the deduction request amount may result in the recovery of the deduction amount requested, as illustrated in block 240. If the requested amount of the deduction is recovered, the total cost of the resources spent researching the deduction request and recovering the requested deduction amount may exceed the amount recovered. Therefore, the seller has lost an amount of money in cost greater than the original amount disputed even though they have recovered some amount. Alternatively, if the requested amount of the deduction is not recovered, as illustrated in block 245, the total cost of the deduction request is the cost of the research and recovery efforts in addition to the unrecovered requested deduction amount.

Referring now to FIG. 3, shown is a block diagram of the system components that allow the efficient processing of a deduction request represented as example method 300. Historical data 305 may be combined with machine learning algorithms 310 to create machine learning models 315. Historical data in this context refers to any data that may be relevant to the processing of the deduction request. Historical data may include all past deduction request data, data related to the outcome of the deduction request, historical order data, or any other historical data that may be beneficial to creating machine learning models 315.

Machine learning models 315 may then process individual deduction requests 320 to calculate an invalid confidence score 325 (e.g., for each one of deduction requests 320). The calculation of invalid confidence score 325 may also include categorization of an individual deduction request (selected from the set of deduction requests 320) to indicate how this individual deduction request may be processed by suggested actions 330. Suggested actions 330 may include, but is not be limited to, automatically approving the individual deduction request, automatically denying the individual deduction request, or holding the disposition of an individual deduction request for further processing (e.g., by a collection analyst). The result of the processing each of deduction requests 320 and an individual action taken (block 335) may be cataloged in historical data 305 for future use. Machine learning models 315 may, as a result, continuously updated over time to learn how to more accurately produce invalid confidence score 325.

Referring to FIG. 4, shown is a process flow diagram illustrating an example efficient processing of a deduction request (e.g., a deduction request selected from a set of deduction requests similar to deduction requests 320) is represented as an example method 400. Beginning in block 405, a deduction request may be created. Flow continues to block 410 where the deduction request may be evaluated by machine learning models that have, for example, been created from combining historical data and machine learning algorithms. Continuing to block 415, a score is calculated as an indication of the confidence level that the deduction request is invalid. The flow continues to block 420 where data such as the amount of the deduction request and the confidence score that the deduction request is invalid may be used to categorize the deduction request.

Flow continues to decision 425 where the category of the deduction request may be evaluated to assess if the deduction request may be automatically processed. If the deduction request may be automatically processed, flow continues through the YES prong of decision 425 and the deduction request is approved (block 435). If the deduction request may not be automatically processed, flow continues through the NO prong of decision 425 to block 430. As indicated at block 430, deduction requests that are not automatically processed may be held for further analysis and prioritized accordingly. The additional analysis may include additional automated review or initiating a manual process for the deduction request.

Referring to FIG. 5, shown is an example computing device 500, with a hardware processor 501, and accessible machine-readable instructions stored on a machine-readable medium 502 that may be used to develop and execute the example method 400, according to one or more disclosed example implementations. FIG. 5 illustrates computing device 500 configured to perform the flow of method 400, as an example. However, computing device 500 may also be configured to perform the flow of other methods, techniques, functions, or processes described in this disclosure. In this example of FIG. 5, machine-readable storage medium 502 includes instructions to cause hardware processor 501 to perform blocks 405-435 discussed above with reference to FIG. 4.

A machine-readable storage medium, such as 502 of FIG. 5, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

FIG. 6 represents a computer network infrastructure that may be used to implement all or part of the disclosed predictive analysis for abnormal event resolution techniques, according to one or more disclosed implementations. Network infrastructure 600 includes a set of networks where embodiments of the present disclosure may operate. Network infrastructure 600 comprises a customer network 602, network 608, cellular network 603, and a cloud service provider network 610. In one embodiment, the customer network 602 may be a local private network, such as local area network (LAN) that includes a variety of network devices that include, but are not limited to switches, servers, and routers.

Each of these networks can contain wired or wireless programmable devices and operate using any number of network protocols (e.g., TCP/IP) and connection technologies (e.g., WiFi® networks, or Bluetooth®. In another embodiment, customer network 602 represents an enterprise network that could include or be communicatively coupled to one or more local area networks (LANs), virtual networks, data centers and/or other remote networks (e.g., 608, 610). In the context of the present disclosure, customer network 602 may include multiple devices configured with the disclosed system implementing the components for processing deduction requests such as those described above. Also, one of the many computer storage resources in customer network 602 (or other networks shown) may be configured to store the historical data 305 of FIG. 3.

As shown in FIG. 6, customer network 602 may be connected to one or more client devices 604A-E and allow the client devices 604A-E to communicate with each other and/or with cloud service provider network 610, via network 608 (e.g., Internet). Client devices 604A-E may be computing systems such as desktop computer 604B, tablet computer 604C, mobile phone 604D, laptop computer (shown as wireless) 604E, and/or other types of computing systems generically shown as client device 604A.

Network infrastructure 600 may also include other types of devices generally referred to as Internet of Things (IoT) (e.g., edge IOT device 605) that may be configured to send and receive information via a network to access cloud computing services or interact with a remote web browser application (e.g., to receive configuration information).

FIG. 6 also illustrates that customer network 602 includes local compute resources 606A-C that may include a server, access point, router, or other device configured to provide for local computational resources and/or facilitate communication amongst networks and devices. For example, local compute resources 606A-C may be one or more physical local hardware devices that may be working cooperatively to execute multiple concurrent instances of the efficient processing of deduction requests flow 400 referring to FIG. 4. Local compute resources 606A-C may also facilitate communication between other external applications, data sources (e.g., 607A and 607B), and services, and customer network 602. Local compute resource 606C illustrates a possible processing system cluster with three nodes. Of course, any number of nodes is possible, but three are shown in this example for illustrative purposes.

Network infrastructure 600 also includes cellular network 603 for use with mobile communication devices. Mobile cellular networks support mobile phones and many other types of mobile devices such as laptops etc. Mobile devices in network infrastructure 600 are illustrated as mobile phone 604D, laptop computer 604E, and tablet computer 604C. A mobile device such as mobile phone 604D may interact with one or more mobile provider networks as the mobile device moves, typically interacting with a plurality of mobile network towers 620, 630, and 640 for connecting to the cellular network 603.

Although referred to as a cellular network in FIG. 6, a mobile device may interact with towers of more than one provider network, as well as with multiple non-cellular devices such as wireless access points and routers (e.g., local compute resources 606A-C). In addition, the mobile devices may interact with other mobile devices or with non-mobile devices such as desktop computer 604B and various types of client device 604A for desired services. Although not specifically illustrated in FIG. 6, customer network 602 may also include a dedicated network device (e.g., gateway or router) or a combination of network devices (not shown) that implement a customer firewall or intrusion protection system.

FIG. 6 illustrates that customer network 602 is coupled to a network 608. Network 608 may include one or more computing networks available today, such as other LANs, wide area networks (WAN), the Internet, and/or other remote networks, in order to transfer data between client devices 604A-D and cloud service provider network 610. Each of the computing networks within network 608 may contain wired and/or wireless programmable devices that operate in the electrical and/or optical domain.

In FIG. 6, cloud service provider network 610 is illustrated as a remote network (e.g., a cloud network) that is able to communicate with client devices 604A-E via customer network 602 and network 608. The cloud service provider network 610 acts as a platform that provides additional computing resources to the client devices 604A-E and/or customer network 602. In one embodiment, cloud service provider network 610 includes one or more data centers 612 with one or more server instances 614.

FIG. 7 illustrates a computer processing device 700 that may be used to implement the functions, modules, processing platforms, execution platforms, communication devices, and other methods and processes of this disclosure. For example, computing device 700 illustrated in FIG. 7 could represent a client device or a physical server device and include either hardware or virtual processor(s) depending on the level of abstraction of the computing device. In some instances (without abstraction), computing device 700 and its elements, as shown in FIG. 7, each relate to physical hardware. Alternatively, in some instances one, more, or all of the elements could be implemented using emulators or virtual machines as levels of abstraction. In any case, no matter how many levels of abstraction away from the physical hardware, computing device 700 at its lowest level may be implemented on physical hardware.

As also shown in FIG. 7, computing device 700 may include one or more input devices 730, such as a keyboard, mouse, touchpad, or sensor readout (e.g., biometric scanner) and one or more output devices 715, such as displays, speakers for audio, or printers. Some devices may be configured as input/output devices also (e.g., a network interface or touchscreen display).

Computing device 700 may also include communications interfaces 725, such as a network communication unit that could include a wired communication component and/or a wireless communications component, which may be communicatively coupled to processor 705. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi®, cellular, and/or other communication methods.

As illustrated in FIG. 7, computing device 700 includes a processing element such as processor 705 that contains one or more hardware processors, where each hardware processor may have a single or multiple processor cores. In one embodiment, the processor 705 may include at least one shared cache that stores data (e.g., computing instructions) that are utilized by one or more other components of processor 705. For example, the shared cache may be a locally cached data stored in a memory for faster access by components of the processing elements that make up processor 705. In one or more embodiments, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 7, the processing elements that make up processor 705 may also include one or more of other types of hardware processing components, such as graphics processing units (GPU), application specific integrated circuits (ASICs), field-programmable gate arrays (FPGAs), and/or digital signal processors (DSPs).

FIG. 7 illustrates that memory 710 may be operatively and communicatively coupled to processor 705. Memory 710 may be a non-transitory medium configured to store various types of data. For example, memory 710 may include one or more storage devices 720 that comprise a non-volatile storage device and/or volatile memory. Volatile memory, such as random-access memory (RAM), can be any suitable non-permanent storage device. The non-volatile storage devices 720 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 720 may be used to store overflow data if allocated RAM is not large enough to hold all working data. The non-volatile storage devices 720 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 705. In one embodiment, the compiling process of the software program may transform program code written in a programming language to another computer language such that the processor 705 is able to execute the programming code. For example, the compiling process of the software program may generate an executable program that provides encoded instructions (e.g., machine code instructions) for processor 705 to accomplish specific, non-generic, particular computing functions.

After the compiling process, the encoded instructions may then be loaded as computer executable instructions or process steps to processor 705 from storage device 720, from memory 710, and/or embedded within processor 705 (e.g., via a cache or on-board ROM). Processor 705 may be configured to execute the stored instructions or process steps in order to perform instructions or process steps to transform the computing device into a non-generic, particular, specially programmed machine or apparatus. Stored data, e.g., data stored by a storage device 720, may be accessed by processor 705 during the execution of computer executable instructions or process steps to instruct one or more components within the computing device 700.

A user interface (e.g., output devices 715 and input devices 730) can include a display, positional input device (such as a mouse, touchpad, touchscreen, or the like), keyboard, or other forms of user input and output devices. The user interface components may be communicatively coupled to processor 705. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 700 may comprise other components well known in the art, such as sensors, powers sources, and/or analog-to-digital converters, not explicitly shown in FIG. 7.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A computer system comprising:
one or more processors;
a memory communicatively coupled to the one or more processors and storing instructions executable by the one or more processors to cause the computer system to:
receive a first abnormal event resolution request in response to an initiating event, the first abnormal event resolution request containing a set of attributes;
obtain historical information regarding previous processing of a set of abnormal event resolution requests related to the first abnormal event resolution request based on the set of attributes;
evaluate the first abnormal event resolution request using machine learning and the historical information to determine a confidence level score, the confidence level score providing an indication of validity with respect to the first abnormal event resolution request;
categorize the first abnormal event resolution request based on a value attributed to the first abnormal event resolution request and the confidence level score;
determine if the first abnormal event resolution request qualifies for automatic resolution;
based on a determination that automatic resolution is appropriate, automatically resolve the first abnormal event resolution request; and
based on a determination that automatic resolution is not appropriate, queue the first abnormal event resolution request for further processing.

2. The computer system of claim 1, wherein the first abnormal event resolution request represents a deduction request.

3. The computer system of claim 2, wherein the instructions to cause the one or more processing units to automatically resolve the deduction request include instructions to resolve the deduction request, at least in part, by adjusting an invoice amount to accept the deduction, wherein the invoice amount is based on an attribute of the initiating event.

4. The computer system of claim 1, wherein the instructions to cause the computer system to categorize the first abnormal event resolution request further comprise instructions to associate the first abnormal event resolution request with additional requests in a quick review category.

5. The computer system of claim 4, wherein the quick review category includes a plurality of abnormal event resolution requests each representing an individual deduction request that is related to other instances of deduction requests in the plurality by an amount in dispute being below a threshold amount.

6. A computer-implemented method comprising:
receiving a first abnormal event resolution request in response to an initiating event, the first abnormal event resolution request containing a set of attributes;
obtaining historical information regarding previous processing of a set of abnormal event resolution requests related to the first abnormal event resolution request based on the set of attributes;
evaluating the first abnormal event resolution request using machine learning and the historical information to determine a confidence level score, the confidence level score providing an indication of validity with respect to the first abnormal event resolution request;
categorizing the first abnormal event resolution request based on a value attributed to the first abnormal event resolution request and the confidence level score;
determining if the first abnormal event resolution request qualifies for automatic resolution;
based on a determination that automatic resolution is appropriate, automatically resolving the first abnormal event resolution request; and
based on a determination that automatic resolution is not appropriate, queuing the first abnormal event resolution request for further processing.

7. The computer-implemented method of claim 6, wherein the first abnormal event resolution request represents a deduction request.

8. The computer-implemented method of claim 7, wherein the automatically resolving the deduction request includes adjusting an invoice amount to accept the deduction, wherein the invoice amount is based on an attribute of the initiating event.

9. The computer-implemented method of claim 6, wherein the categorizing the first abnormal event resolution request includes associating the first abnormal event resolution request with additional requests in a quick review category.

10. The computer-implemented method of claim 9, wherein the quick review category includes a plurality of abnormal event resolution requests each representing an individual deduction request that is related to other instances of deduction requests in the plurality by an amount in dispute being below a threshold amount.

11. A non-transitory computer readable medium comprising computer executable instructions that, when executed by one or more processing units, cause the one or more processing units to:
receive a first abnormal event resolution request in response to an initiating event, the first abnormal event resolution request containing a set of attributes;
obtain historical information regarding previous processing of a set of abnormal event resolution requests related to the first abnormal event resolution request based on the set of attributes;
evaluate the first abnormal event resolution request using machine learning and the historical information to determine a confidence level score, the confidence level score providing an indication of validity with respect to the first abnormal event resolution request;
categorize the first abnormal event resolution request based on a value attributed to the first abnormal event resolution request and the confidence level score;
determine if the first abnormal event resolution request qualifies for automatic resolution;
based on a determination that automatic resolution is appropriate, automatically resolve the first abnormal event resolution request; and
based on a determination that automatic resolution is not appropriate, queue the first abnormal event resolution request for further processing.

12. The non-transitory computer readable medium of claim 11, wherein the first abnormal event resolution request represents a deduction request.

13. The non-transitory computer readable medium of claim 12, wherein the instructions to cause the one or more processing units to automatically resolve the deduction request include instructions to resolve the deduction request, at least in part, by adjusting an invoice amount to accept the deduction, wherein the invoice amount is based on an attribute of the initiating event.

14. The non-transitory computer readable medium of claim 11, wherein the instructions to cause the computer system to categorize the first abnormal event resolution request further comprise instructions to associate the first abnormal event resolution request with additional requests in a quick review category.

15. The non-transitory computer readable medium of claim 14, wherein the quick review category includes a plurality of abnormal event resolution requests each representing an individual deduction request that is related to other instances of deduction requests in the plurality by an amount in dispute being below a threshold amount.
